(19) United States
(12) Patent Application Publication
(10) Pub. No.: US 2013/0203923 A1
(43) Pub. Date: Aug. 8, 2013

(54) OUTER CASING FOR ELECTRIC DEVICE

(71) Applicant: Panasonic Corporation, Osaka (JP)

(72) Inventor: Takehiko YAMASHITA, Hyogo (JP)

(73) Assignee: Panasonic Corporation, Osaka (JP)

(21) Appl. No.: 13/781,700

(22) Filed: Feb. 28, 2013

Related U.S. Application Data
(63) Continuation of application No. PCT/JP2012/004626, filed on Jul. 20, 2012.

(30) Foreign Application Priority Data
Jan. 25, 2012 (JP) 2012-012710

(51) Int. Cl. C08K 3/32; C08L 67/04

(52) U.S. Cl. CPC C08K 3/32; C08L 67/04
USPC 524/416

(57) ABSTRACT

An outer casing for an electric device is obtained by molding a flame-retarded resin composition including a resin component containing 50% by weight or more of poly(lactic acid) and/or a lactic acid copolymer, of which each is an environmental resin, and silica-magnesia catalyst particles and a polyphosphate salt as flame retardance-imparting components which impart flame retardancy, wherein the combined content of the silica-magnesia catalyst particles and the polyphosphate salt is 10% by weight or less of the total weight of the flame-retarded resin composition.

### CROSS REFERENCE TO RELATED APPLICATIONS

This is a continuation application of PCT Application No. PCT/JP2012/004626, filed on Jul. 20, 2012, designating the United States of America, which claims the priority of Japanese Patent Application No. 2012-012710, filed on Jan. 25, 2012, the disclosure of which, including the specifications, drawings, and claims, are incorporated herein by reference in their entireties.

### BACKGROUND OF THE INVENTION

1. Field of the Invention

The present disclosure relates to outer casings which are used in electric devices, for example, electric appliances such as thin, lightweight and flat display devices, and common electronic components such as resistors and speakers.

2. Description of the Related Art

As flat display devices, liquid crystal displays, organic EL displays, plasma displays and the like are produced in a commercial basis. Since liquid crystal displays and plasma displays in particular are thin and capable of displaying on large screens, they have become widely and commonly used as displays in public facilities and the like, in addition to ordinary households.

In cases of such display devices, resin molded articles are employed as their outer casings so as to meet design requests and to make them lighter. With these display devices becoming widely used, there is being posed, as a problem, disposal treatment of resin molded articles when spent devices are disposed of.

Recently, attention has been directed to resins (or plastics) which decompose by bacterial action when they are buried in the ground. These resins, which are called biodegradable resins (or plastics), have characteristics of being degraded into water (H₂O) and carbon dioxide (CO₂) in the presence of aerobic bacteria. Biodegradable resins are in practical use in the field of agriculture and also in practical use, for example, as packaging materials for disposable articles and as materials of compostable garbage bags.

Articles using biodegradable resins, for example, when used in the field of agriculture, may be advantageous also to users because spent plastics do not need to be collected. Further, in recent days, plant-derived resins are also receiving attention in the fields of electronic devices and automobiles. Plant-derived resins are obtained by polymerization or co-polymerization of monomers obtained from plant materials. Plant-derived resins receive attention as earth-conscious resins, for example, for reasons that they can be produced without relying on oil resources, that plants used as raw materials absorb carbon dioxide and grow, and that their combustion calories are generally low and the amount of generated CO₂ is small even when their disposal is performed by an incineration treatment. Plant-derived resins are generally biodegradable, but do not necessarily need to be biodegradable when considered only from a viewpoint of preventing the depletion of oil resources. From this, resins which contribute to environmental protection will include, in addition to biodegradable resins, plant-derived resins which are not biodegradable. Hereinafter, these resins are referred to collectively as “environmental resins”.

At present, resins which are in use as environmental resins are divided into three main classes: those based on poly(lactic acid) (hereinafter, sometimes referred to as “PLA”), on PBS (polybutylene succinate (a copolymeric resin of 1,4-butanediol and succinic acid)), and on PET (modified polyethylene terephthalate).

Among these resins, PLAs can be produced by chemical synthesis in which sugars generated by plants such as corns or sweet potatoes are used as raw materials, and have a possibility of industrial production. Plastics containing such plant-derived resins are referred to as bioplastics. Particular attention is paid to PLAs because mass production of PLAs has been begun using corns as raw material, and thus there is a desire to develop a technology by which PLAs can be applied not only to applications requiring biodegradation properties, but also to a wide variety of applications.

As methods for improving characteristics of such environmental resins, there were proposed methods by which other components were incorporated into them. For example, JP-A 2002-173583 proposes that synthetic mica is incorporated into PLA in the order of 0.5% to 20% by weight, in order to improve the heat resistance of the PLA.

In addition, there was reported the possibility of applying of PLAs to personal-computer outer casings by incorporating kenaf fibers into PLAs (Serizawa et al., “Development of Kenaf-Fiber-Reinforced Poly(lactic acids),” Proceedings of the 14th Annual Meeting of the Japan Society of Polymer Processing, pp. 161-162, 2003). Specifically, it was reported that after molding PLA resins having kenaf fibers incorporated therein, the addition of an annealing step resulted in an improved heat resistance of the PLA resins, thereby leading to a higher possibility of applying PLAs to personal-computer outer casings.

### SUMMARY OF THE INVENTION

However, the resin compositions described in the above-mentioned documents, JP-A 2002-173583 and Serizawa et al., “Development of Kenaf-Fiber-Reinforced Poly(lactic acids),” Proceedings of the 14th Annual Meeting of the Japan Society of Polymer Processing, pp. 161-162, 2003 are those proposed for the purpose of improving heat resistance, and none of these documents mentions imparting of flame retardance to the resin compositions which is absolutely necessary for applying them to outer casings of electric devices represented by home appliances. Actually, the resin compositions described in the above-mentioned documents do not have flame retardance. Thus, none of the PLA compositions which have been proposed in the past can be applied to outer casings of electric appliances such as television sets having high-voltage parts in their inside. In addition, recent electric appliances emphasize safety and there is a tendency to employ flame-retarded resins even in cases of electric devices having no high-voltage elements in their inside. Therefore, even though environmental resins have characteristics satisfactory in stiffness, impact strength, heat resistance and the like, their usefulness will be extremely low unless they have flame retardancy.

The present disclosure provides an outer casing for an electric device which is molded using an environmental resin wherein poly(lactic acid) (PLA) or a lactic acid copolymer is employed.

The present disclosure provides an outer casing for an electric device, which is obtained by molding a flame-retarded resin composition including a resin component containing 50% by weight or more of poly(lactic acid) and/or a lactic acid copolymer, and silica-magnesia catalyst particles and a polyphosphate salt as flame retardance-imparting components which impart flame retardancy, wherein the combined content of the silica-magnesia catalyst particles and the polyphosphate salt is 10% by weight or less of the total weight of the flame-retarded resin composition.

The present disclosure also provides a resin molded article, which is obtained by molding a flame-retarded resin composition including a resin component containing 50% by weight or more of poly(lactic acid) and/or a lactic acid copolymer, and silica-magnesia catalyst particles and a polyphosphate salt as flame retardance-imparting components which impart flame retardancy, wherein the combined content of the silica-magnesia catalyst particles and the polyphosphate salt is 10% by weight or less of the total weight of the flame-retarded resin composition.

According to the present disclosure, it is possible to impart flame retardancy to environmental resins which are earth-conscious and preferably biodegradable and furthermore to adequately ensure the moldability of the resins. Therefore, outer casings for electric devices according to the present disclosure are not only earth-conscious, but also superior in flame retardance, and thus are suitable for use in a variety of electric devices, including products which are exposed to increased temperatures during their use.

### BRIEF DESCRIPTION OF THE DRAWINGS

FIG. 1 is a front elevation view showing the appearance of a liquid crystal display device as an example of electric devices according to an embodiment.

FIG. 2 is a perspective view showing a state where a stand is removed in the liquid crystal display device shown in FIG. 1.

FIG. 3 is a block diagram showing circuit blocks in the whole configuration of the liquid crystal display device shown in FIG. 1.

FIG. 4 is a plane view showing an example of layout of the circuit blocks of the liquid crystal display device shown in FIG. 1 with the back cabinet being removed to explain the example of layout.

FIG. 5 is a flow diagram for producing an outer casing for an electric device according to the present disclosure.

### DETAILED DESCRIPTION OF THE INVENTION

An embodiment of an outer casing for an electric device according to the present disclosure will be described below with reference to the accompanying drawings.

It should be noted that the present inventor provides the attached drawings and the following description such that those skilled in the art understand the present disclosure sufficiently, and these are not intended to limit the subject matters described in the claims.

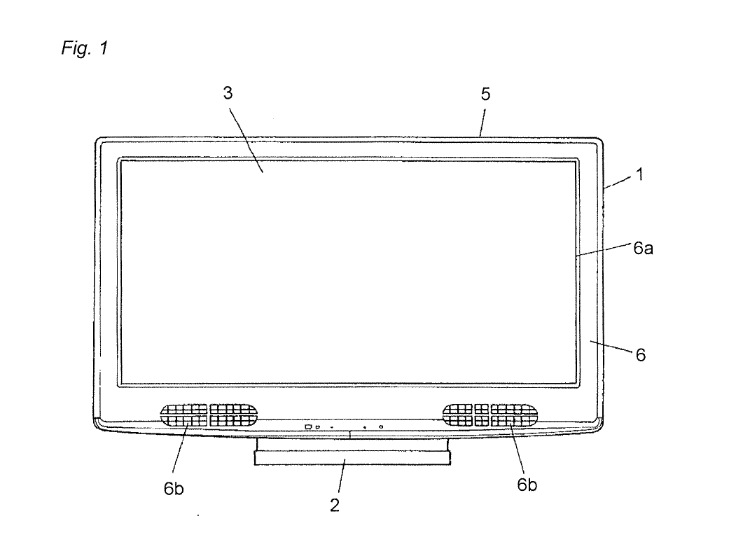

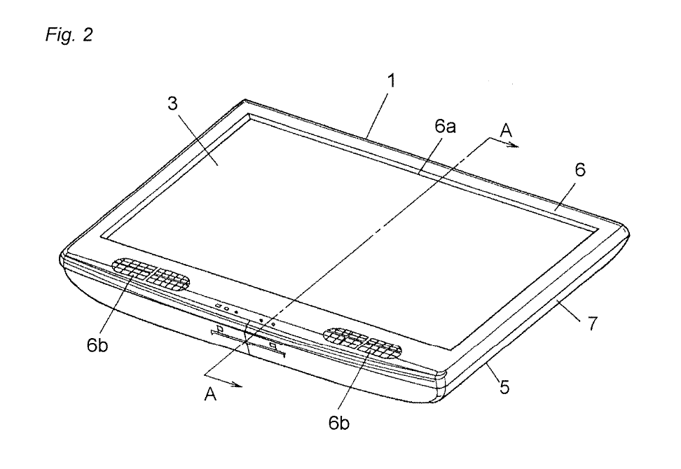

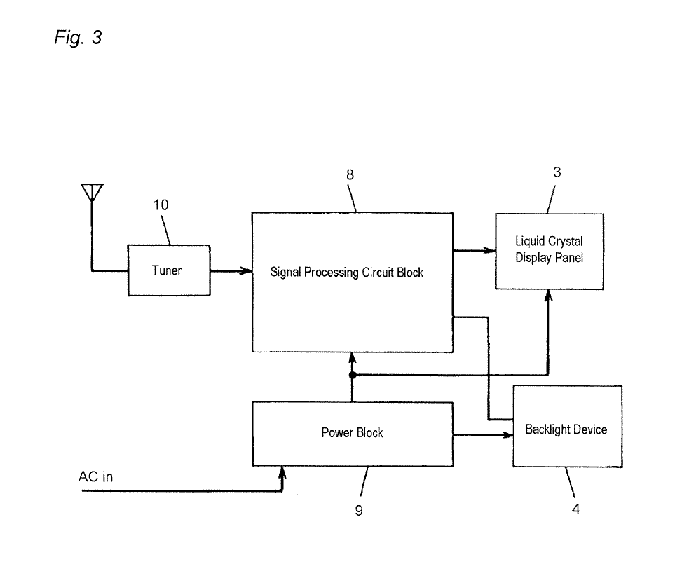

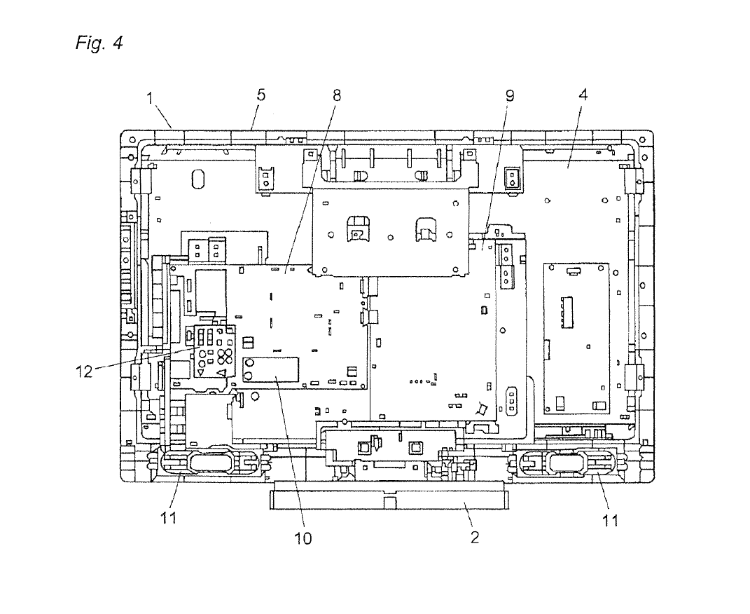

FIGS. 1 and 2 are a front elevation view and a perspective view showing the appearance of a liquid crystal display device as an example of electric devices according to an embodiment, respectively. FIG. 3 is a block diagram showing circuit blocks in the whole configuration of the liquid crystal display device, and FIG. 4 is a plan view showing an example of layout of the circuit blocks of the liquid crystal display device with the back cabinet being removed to explain the example of layout.

As shown in FIGS. 1 and 2, a liquid crystal display device has a display device body 1 and a stand 2 for retaining the display device body 1 in a state allowing it to stand up. The display device body 1 is made up by placing a display module consisting of a liquid crystal display panel 3, which is a flat display panel, and a backlight device (not shown in FIGS. 1 and 2) into an outer casing 5 of a resin molded article or the like. The outer casing 5 is composed of a front cabinet 6 with an opening 6a provided therein so as to conform to the image display area of the liquid crystal display panel 3; and a back cabinet 7 to be combined with the front cabinet 6. 6b refers to a speaker grille for releasing sounds emanated from a speaker to the outside.

As shown in FIGS. 3 and 4, a rough configuration of the whole liquid crystal display device is one which has a signal processing circuit block 8 comprising a driving circuit for displaying images on a liquid crystal display panel 3 and a lighting control circuit for controlling lighting of a backlight device 4; a power block 9 for supplying source voltages to the liquid crystal display panel 3, the backlight device 4, and the signal processing circuit block 8; a tuner 10 for receiving television broadcasting to provide the received signal to the signal processing circuit block 8; and a speaker 11 for outputting sound. The signal processing circuit block 8 and the power block 9 are both made by mounting the parts composing the circuit on a circuit board. The circuit board on which the signal processing circuit block 8, the power block 9, the tuner 10 and the like have been mounted is fixed such that it is positioned in the space between the back side of the backlight device 4 and the back cabinet 7.

In FIG. 3, the rough configuration is shown with the speaker being omitted. In FIG. 4, the reference numeral 12 refers to external signal input terminals for inputting image signals from external devices, such as DVD players, to the liquid crystal display device and is mounted in the signal processing circuit block 8.

The present disclosure is directed to an outer casing for a display device, such as the liquid crystal display device as described above, or for another electric device, which is obtained by molding a flame-retarded resin composition including a resin component containing as the main ingredient 50% by weight or more of poly(lactic acid) and/or a lactic acid copolymer, and silica-magnesia catalyst particles and a polyphosphate salt as flame retardance-imparting components which impart flame retardance, wherein the combined content of the silica-magnesia catalyst particles and the polyphosphate salt is 10% by weight or less of the total weight of the flame-retarded resin composition.

The present inventors have found that by combining particles of a silica-magnesia catalyst, which is one used in purification, cracking, synthesis, or reforming of hydrocarbons, and a polyphosphate salt, a high degree of flame retardance was able to imparted to poly(lactic acid) and/or a lactic acid copolymer. The present inventors performed experiments concerning the content of silica-magnesia catalyst particles. From results of the experiments, it was found that when the content of silica-magnesia catalyst particles was 9.7% by weight or less, for example, 0.3% or more and 9.7% or less by weight, of the total weight of the flame-retarded resin composition, it was made possible to impart high flame retardance to environmental resins and, in addition, to ensure sufficient moldability of the resins, of which outer casings for electric devices were able to be composed.

As used herein, “flame retardance” or “flame retardancy” refers to properties by which the combustion does not continue or no afterglow is brought about when the source of ignition is removed. As used herein, “flame retardance-imparting component” which imparts flame retardancy refers to a component which makes a resin flame-retardant by its addition thereto. Silica-magnesia catalyst particles as the flame retardance-imparting component used in the present disclosure are of a catalyst which is used in purification, cracking, synthesis, and/or reforming of hydrocarbons and which is in the form of compounds that do not contain halogens at all or are difficult to generate dioxins. In the present disclosure, a catalyst as the flame retardance-imparting component exerts effects characteristic of the catalyst during the combustion reactions of the resin component in the process where the resin component actually burns, when the catalyst and the resin component are kneaded in advance, thereby to disperse the catalyst into the resin component. These catalytic effects significantly contribute to making the resin flame-retardant.

When the silica-magnesia catalyst particles are subjected to high temperatures (for example, in the order of 500° C. or higher) during combustion, the silica-magnesia catalyst particles cut macromolecules, which are of the resin component, from their ends, thereby decomposing them into lower molecular-weight molecules. If the molecular weights of molecules after the decomposition are small, then the total molecular weight of the flammable gases belching by thermal decomposition is decreased, whereby making the resin component flame-retardant would be achieved. In general, the combustion of a resin continues by the combustion cycle that the energy which is generated when molecules produced by thermal decomposition of the resin during the combustion are burned is provided to the resin as radiation heat, which causes further thermal decomposition of the resin and combustion of molecules produced by the decomposition. If the molecular weight of molecules produced by decomposition of a resin is larger, and thus more gases as fuel are supplied, then the energy of combustion will become higher. In addition, as the energy of combustion becomes great, the radiation heat in the combustion field is increased and the combustion of the resin lasts for a longer period of time. Therefore, when a resin is cut at the same number of times, decomposing of the resin into molecules with smaller molecular weights is preferable in that the energy of combustion is decreased and the thermal decomposition of the resin is suppressed. Silica-magnesia catalyst particles would exert catalytic effects so as to decompose a resin into molecules with smaller molecular weights during the combustion of the resin.

This flame-proofing mechanism is different from those of halogen-based and phosphorus-based flame retardants. For example, in the case of halogen-based flame retardants represented by bromine-based flame retardants, halogen-containing gas components generated by thermal decomposition capture radicals released from a resin in the vapor phase, thereby suppressing combustion reactions. It is said that the phosphorous-based flame retardants facilitate the formation of a carbonized (char) layer during the combustions, which blocks oxygen and radiation heat, thereby suppressing the combustion.

However, when a large amount of silica-magnesia catalyst particles, which have catalytic activity, is contained in the resin composition, there may be caused disadvantages, for example, decomposing of the resin during its molding. To address this, the present disclosure employs a polyphosphate salt as an additional flame retardance-imparting component, in order to reduce the amount of silica-magnesia catalyst particles.

The flame-retarded resin composition which composes an outer casing for an electric device according to the present disclosure will be described in more detail below.

First, the resin component will be described.

The flame-retarded resin composition which composes an outer casing according to the present disclosure contains poly(lactic acid) (PLA) and/or a lactic acid copolymer as the resin component. PLA and a lactic acid copolymer are a resin which is obtained by using lactic acid as raw material and polymerizing it or co-polymerizing it with other monomer(s). Lactic acid can be obtained, for example, by fermentation of starch or sugars which are obtained from corns, sweet potatoes, or the like. Therefore, PLAs and lactic acid copolymers can be supplied as plant-derived resin. Many of PLAs and lactic acid copolymers have biodegradation properties. Therefore, PLAs and lactic acid copolymers are environmental resins.

PLAs and lactic acid copolymers, particularly PLAs, have superior transparency and stiffness, and thus molded articles composed of these can be used for various applications. On the other hand, PLAs and lactic acid copolymers have disadvantages of exhibiting a decreased resistance to heat and impact and a slightly decreased injection moldability. For these reasons, PLAs and lactic acid copolymers are preferably used in mixture with other resin(s) and/or modifier(s), particularly when they are injection molded. For example, since PBSs have superior heat resistance and are biodegradable per se, they are suitable for mixing into PLAs and lactic acid copolymers. Alternatively, PLAs and lactic acid copolymers may be modified using agents which are commercially available as poly(lactic acid) modifiers.

Poly(lactic acid) may be one known in the art. For example, poly(lactic acid) may include a poly(L-lactic acid) consisting of the L-lactic acid unit; a poly(D-lactic acid) consisting of the D-lactic acid unit; a mixture comprising a poly(lactic acid) stereo-complex formed by mixing a poly(L-lactic acid) and a poly(D-lactic acid); or a poly(lactic acid) block copolymer obtained by solid polymerization of this mixture.

The lactic acid copolymer is a copolymer which is obtained, for example, by co-polymerizing L-lactide and/or D-lactide made from using L-lactic acid and/or D-lactic acid, with an oxyacid, lactone, dicarboxylic acid, or polyhydric alcohol co-polymerizable therewith (for example, caprolactone or glycolic acid).

An outer casing according to the present disclosure contains PLA and/or a lactic acid copolymer as the resin component, wherein the PLA and/or the lactic acid copolymer accounts for 50% by weight or more of the total weight of the resin component as the main ingredient. An outer casing wherein PLA and/or a lactic acid copolymer constitutes 50% by weight or more of the whole resin component is capable of its easy disposal. PLA and lactic acid copolymers are polymers of which flame retardancy tends to be improved by addition of silica-magnesia catalyst particles and a polyphosphate salt, in comparison with other polymers. Therefore, the flame retardance-imparting effect of the silica-magnesia catalyst particles and the polyphosphate salt can be favorably given when 50% by weight or more of the whole resin component is constituted by PLA and/or a lactic acid copolymer, resulting in reduction in the proportion of the added flame retardance-imparting component. PLA and/or a lactic acid copolymer accounts for preferably 60% by weight, more preferably 70% by weight or more, further more preferably 80% by weight or more, particularly preferably 85% by weight or more, most preferably 90% by weight or more, and optionally 100% by weight, of the resin component (that is, only PLA and/or a lactic acid copolymer may be contained as the resin component).

In an outer casing, PLA and/or a lactic acid copolymer accounts for preferably 70% by weight or more, 80% by weight or more, or 85% by weight or more, or most preferably 90% by weight or more, of the flame-retarded resin composition. When PLA and/or a lactic acid copolymer accounts for 70% by weight or more of a flame-retarded resin composition, the resin composition can be disposed of with ease. Other ingredients than the PLA and/or the lactic acid copolymer in the flame-retarded resin composition are other resin ingredient(s), a flame retardance-imparting component as described below, an optionally added additive(s) and the like.

In the outer casing, the resin component comprising poly(lactic acid) as the main ingredient may comprise other resin(s). Specifically, in an outer casing according to the present disclosure, the resin component of which the main ingredient is poly(lactic acid) and/or the lactic acid copolymer may include one or more resins selected from:

a thermoplastic resin, such as polyethylene, polypropylene, polystyrene, an ethylene vinyl acetate copolymer, poly(vinyl chloride), acrylonitrile-styrene (AS), an acrylonitrile/butadiene/styrene (ABS) copolymer and a mixture, poly(ethylene terephthalate) (PET), and poly(butylene terephthalate) (PBT);

a thermoplastic elastomer, such as a butadiene rubber (BR), an isoprene rubber (IR), a styrene/butadiene copolymer (SBR), a hydrogenated styrene/butadiene copolymer (HSBR), and a styrene/isoprene copolymer (SIR);

a thermoplastic engineering resin, such as polyamide (PA), polycarbonate (PC), and polyphenylene ether (PPE);

a super-engineering resin, such as polyarylate (PAR) and polyether ether ketone (PEEK); and

a thermosetting resin, such as an epoxy resin (EP), a vinyl ester resin (VE), polyimide (PI), and polyurethane (PU).

Silica-magnesia (SiO₂/MgO) catalyst particles which are a flame retardance-imparting component which imparts flame retardancy will be descried below.

The silica-magnesia catalyst particles are those of a solid acid catalyst, which is prepared, for example, by hydrothermal synthesis, and is a double oxide of silicon oxide (silica) and magnesium oxide (magnesia) or a catalyst which is formed by binding both silicon oxide (silica) and magnesium oxide (magnesia). The silica-magnesia catalyst particles function as a catalyst which decomposes hydrocarbons at the time of burning of resin composition, for example, under elevated temperatures of about 500° C. or higher, as described above. On the other hand, metal oxides or mineral materials containing metal oxides (for example, talc) which are used as filler, do not exhibit any catalytic effects even under such elevated temperatures. Therefore, silica-magnesia catalyst particles are distinguished from such metal oxides or mineral materials.

In the outer casing, it is preferable that the silica-magnesia catalyst particles in a state having no crystal water form a mixture with the resin component. In some cases, the silica-magnesia catalyst particles having crystal water are able to impart little or no flame retardance to the resin component. When a composition or compound (including a double oxide) containing silica and magnesia contains crystal water, its chemical formula may be represented by that having a hydroxyl group. It is preferable, from a viewpoint of imparting satisfactory flame retardancy, that the silica-magnesia catalyst particles which are contained in the outer casing according to the present disclosure are those which do not have such a hydroxyl group(s). Therefore, silica-magnesia catalyst particles which are contained in an outer casing according to the present disclosure are preferably those which do not have hydrogen atoms composing crystal water or a hydroxyl group in the molecule.

In the present disclosure, it is preferable to use silica-magnesia catalyst particles having a percent MgO of 10% to 50% by weight. If the percent MgO of a catalyst is less than 10% by weight, the particles do not exhibit sufficient catalytic effects, that is, the particles have a weak action of decomposition of the resin, resulting in a tendency to reduce the effect of imparting flame retardancy. On the other hand, if the percent MgO of a catalyst is 50% by weight or more, the particles may exhibit too strong catalytic effects, thereby decomposing the resin into higher molecular-weight molecules, resulting in the increase in the amount of combustion heat and the decrease in flame-retardant effects.

In the present disclosure, it is preferable to use silica-magnesia catalyst particles having an average particle diameter of 10 μm or less. The average particle diameter is a particle size that is a median diameter D50, which is determined from particle sizes measured by a laser diffraction/scattering method. When the average particle diameter of silica-magnesia catalyst particles is 10 μm or less, an outer casing having satisfactory flame retardancy can be obtained even though the content of the particles is, for example, 9.7% by weight or less. As the average particle diameter of silica-magnesia catalyst particles becomes decreased, an outer casing having higher flame retardance can be obtained at the same content of the particles. Therefore, the silica-magnesia catalyst particles having a smaller average particle diameter make it possible to obtain the outer casing having desired flame retardancy (for example, grade V0 of the UL 94 Standard), even though the content of the silica-magnesia catalyst particles is decreased.

The silica-magnesia catalyst particles having an average particle diameter of 10 μm or less, for example, 1 μm or more and 10 μm or less, are obtained by pulverizing the silica-magnesia catalyst particles which have larger particle sizes. Pulverizing may be carried out, for example, by using a jet mill.

Preferably, the silica-magnesia catalyst particles are subjected to heat treatment prior to being kneaded with the resin component. This is due to the fact that silica-magnesia catalyst particles are generally supplied in states having no catalytic activity or exhibiting a decreased catalytic activity such that no flame retardance can be imparted. Heat treatment is performed to remove crystal water from the particles. A crystal water refers to a water which coordinates or binds to an element in the molecule, a water which fills a vacant site in the crystal lattice, a water which is contained as OH ion and dehydrated as H₂O upon heating, or the like, and these waters are removed by being heated at elevated temperatures. Removing crystal water from the silica-magnesia catalyst particles requires heat treatments at a temperature of 200° C. or higher, preferably at a temperature of 300 to 500° C. The temperature at which a resin component having poly(lactic acid) and/or a lactic acid copolymer as the main ingredient is kneaded is at the highest in the order of 260° C., and thus the heat treatment for removing any crystal water needs to be carried out separately before the kneading. In addition, heat treatment is preferably carried out in an atmosphere under 0.1 atm or less. Therefore, suction evacuation is preferably performed during the heat treatment.

The silica-magnesia catalyst particles from which crystal water has been removed exhibit high activity, and thus may degrade a resin component in the course in which the particles are added to and kneaded with the resin component. For this reason, when the content of the silica-magnesia catalyst particles is large, there may be caused a decreased molecular weight of the resin component and a reduced moldability. The content of silica-magnesia catalyst particles is preferably 9.7% by weight or less also from a viewpoint of avoiding the decomposition of the resin component during kneading. A preferable lower limit of the content of silica-magnesia catalyst particles is 0.3% by weight.

In the present disclosure, a polyphosphate salt is further used as a flame retardance-imparting component which imparts flame retardance. A polyphosphate salt is, for example, a compound represented by the structural formula shown below:

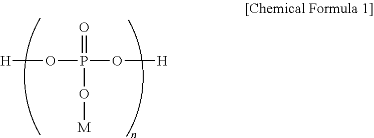

wherein M is Na, K, or NH₄, or another monovalent cation.

In the above-described formula, n (i.e., the number of repeating units of phosphate) is 2 or more, and preferably 2 to 6. M is preferably NH₄; ammonium polyphosphate is preferably used. Ammonium polyphosphate is available from Taiyo Chemical Industry, Co., Ltd., for example.

Polyphosphate salts are known as a suitable flame retardant used in forming carbon foams. Although there are known other phosphorus-containing compounds which can be used as flame retardant, polyphosphate salts exert an enhanced flame-retardant effect when used together with silica-magnesia catalyst particles, in comparison with other phosphorus-containing compounds, and impart high flame retardance particularly to poly(lactic acid) and/or a lactic acid copolymer.

In the present disclosure, it is preferable to use a polyphosphate salt having an average particle diameter of 13 μm or less. The average particle diameter is a median diameter D50, which is determined from particle sizes measured by a laser diffraction/scattering method. When the average particle diameter of the polyphosphate salt is 10 μm or less, an outer casing having satisfactory flame retardance can be obtained even though the content of the polyphosphate salt is, for example, 9.7% by weight or less. As the average particle diameter of the polyphosphate salt becomes decreased, an outer casing having higher flame retardance can be obtained at the same content of the polyphosphate salt. Therefore, the polyphosphate salt having a smaller average particle diameter makes it possible to obtain an outer casing having a desired flame retardance (for example, grade V0 of the UL 94 Standard), even though the content of the polyphosphate salt is decreased. A polyphosphate salt having an average particle diameter of 10 μm or less is available from Taiyo Chemical Industry, Co., Ltd., for example.

The polyphosphate salt and the silica-magnesia catalyst particles together account for 10% by weight or less of the flame-retarded resin composition. When the total contents of the polyphosphate salt and the silica-magnesia catalyst particles is over 10% by weight, moldability of the resin composition is decreased. It is preferable that the polyphosphate salt and silica-magnesia catalyst particles together account for 1.3% by weight or more of the flame-retarded resin composition. When the total contents of the polyphosphate salt and the silica-magnesia catalyst particles is below 1.3% by weight, sufficient flame retardance may not be imparted to the resin composition.

The content of the polyphosphate salt is preferably 9.7% by weight or less. When the content of the polyphosphate salt is more than 9.7% by weight, the polyphosphate salt will scatter in the resin as a powder component other than the resin, whereby a significant change in the flowability of the resin may be caused, resluting in reduction in the moldability of the resin composition. The content of the polyphosphate salt is preferably 0.3% by weight or more. When the content of the polyphosphate salt is less than 0.3% by weight, it is necessary to increase the content of silica-magnesia catalyst particles, in order to ensure flame retardance, and as a consequence of that, the moldability of the resin composition may be reduced due to the catalytic activity of the silica-magnesia catalyst particles.

In some embodiments, the silica-magnesia catalyst particles and the polyphosphate salt may be contained in the flame-retarded resin composition, for example, such that the content of the silica-magnesia catalyst particles is 0.3% by weight or more and the content of the polyphosphate salt is 1% by weight or more. Alternatively, in cases where the content of the polyphosphate salt is 0.3% or more and less than 1% by weight, the content of the silica-magnesia catalyst particles may be 5% or more and 7% or less by weight. In other embodiments, the silica-magnesia catalyst particles and the polyphosphate salt may be contained in the flame-retarded resin composition, for example, such that the content of the silica-magnesia catalyst particles is 0.3% or more and 3% or less by weight and the content of the polyphosphate salt is 1% or more and 5% or less by weight. The lower the combined content of the silica-magnesia catalyst particles and the polyphosphate salt, the better the moldability of the resin composition will become.

The flame-retarded resin composition composing the outer casing according to the present disclosure may include other component(s) in addition to the above-described resin component and the flame retardance-imparting components. As other component(s) are included additives commonly added to resins. Additives are, for example, nucleating agents such as calcium lactate and benzoates; hydrolysis inhibitors such as carbodiimide compounds; antioxidants such as 2,6-di-t-butyl-4-methylphenol and butylated hydroxyanisole; releasing agents such as glycerin mono-aliphatic acid esters, sorbitan aliphatic acid esters, and polyglycerin aliphatic acid esters; colorings such as carbon black, ketjen black, titanium oxide, and lapis lazuli; impact absorbers such as butylene rubbers; anti-fogging agents such as glycerin aliphatic acid esters and monostearyl citrate. The content of these additives is preferably 18% by weight or less, more preferably 10% by weight or less, of the total weight of the flame-retarded resin composition.

The flame-retarded resin composition can be produced by kneading a resin component, flame retardance-imparting components which impart flame retardance (i.e., the silica-magnesia catalyst particles and the polyphosphate salt), and an additive(s) which is/are optionally added. As an example, the flame-retarded resin composition can be produced by a method in which the silica-magnesia catalyst particles and the polyphosphate salt are added in a kneading step wherein the resin component having poly(lactic acid) and/or the lactic acid copolymer as the main ingredient is molten and kneaded. According to this production method, another step for incorporating the flame retardance-imparting components does not take place, and thus the flame-retarded resin composition can be obtained without increasing the production cost so much.

In producing the flame-retarded resin composition, kneading may be carried out, for example, before obtaining pellets in cases of producing pellet-shaped resin compositions. Alternatively, a pellet-shaped resin (or a composition having two or more resins) may be kneaded with the flame retardance-imparting components, followed by forming the mixture into the shape of pellets again. The flame retardance-imparting components may be added to the resin component in the form of masterbatch.

An outer casing according to the present disclosure is obtained by shaping a desired shape from a flame-retarded resin composition by injection molding, extrusion molding, or compression molding. Injection molding and extrusion molding involve a step of melting the flame-retarded resin composition, which is produced by the above-described method, and kneading it by the use of a kneader or the like. Therefore, when these molding methods are employed, adding of the flame retardance-imparting components to the resin component may be carried out in this kneading step. If the flame retardance-imparting components are added in that manner, then another step for adding the flame retardance-imparting components is not required, and thus the outer casing is obtained efficiently.

The outer casing for an electric device according to the present disclosure is used, in particular, as an outer casing for not only the above-described liquid crystal display device, but also for other display devices (plasma display devices, organic EL display devices and the like), for computers, mobile phones, audio products (for example, radios, cassette decks, CD players, MD players), microphones, keyboards, and potable audio players, and for electric parts. Electric devices are not limited to ones for family use. Electric devices include ones for business use, such as industrial use and medical use. The flame-retarded resin composition composing the outer casing according to the present disclosure is preferably employed for making a resin molded article other than the outer casing for an electric device. Resin molded articles are provided, for example, as interior materials of automobiles, exterior materials of two-wheel vehicles, and various household sundry goods.

### EXAMPLES

The present disclosure will be described below by way of Examples.

### Example 1

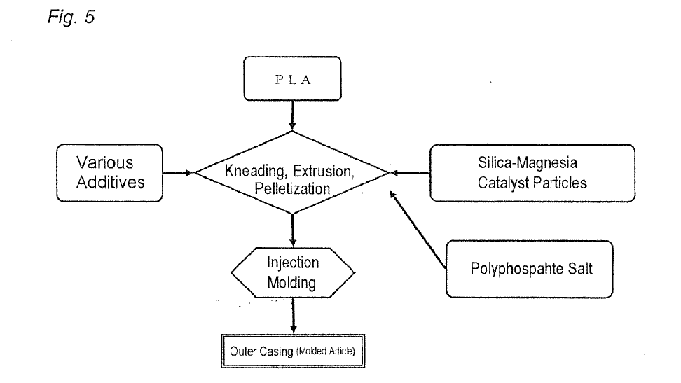

FIG. 5 represents a flow diagram showing a method for producing an outer casing for an electric device (including the sequence of formulating a flame-retarded resin composition), which is used in this Example.

As shown in FIG. 5, to a resin component containing 100% by weight of poly(lactic acid) (PLA) synthesized using corn as raw material, powders of a silica-magnesia catalyst (MgO: 24.5% by weight) with an average particle diameter (D50) of 10 μm and ammonium polyphosphate with an average particle diameter (D50) of 10 μm were kneaded as flame retardance-imparting component employing a twin-screw kneader. Additives were further added: 2% by weight of carbodiimide and 0.5% by weight of each of a ketjen black pigment, Ca lactate, butylated hydroxyanisole, and a glycerin mono-fatty acid ester. After kneading, pellets were producing by extrusion molding. Kneading by the twin-screw kneader was carried out at a temperature of about 185° C. Before the kneading, the silica-magnesia catalyst particles were subjected to heat treatment at 450° C. for 4 hours in an atmosphere where the pressure was reduced to 0.1 atm with suction evacuation. By this heat treatment, crystal water was removed from the silica-magnesia catalyst particles, thereby to stimulate the catalytic activity of the silica-magnesia catalyst particles.

The pellets were used to prepare test specimens using an injection machine. During the injection, the resin temperature was set to be 170±10° C. The shape and dimensions of the test specimens were as follows:

Shape: specimen shape for UL 94 flammability test Dimensions: 125 mm×13 mm×2.5 mm

In this Example, plural types of test specimens were prepared by varying the contents of the silica-magnesia catalyst particles and of the ammonium polyphosphate. Specifically, the content of the silica-magnesia catalyst particles was varied in the range of 0.3% to 9.7% by weight of the entire resin composition, and at the same time, the content of the ammonium polyphosphate was varied in the range of 0.3% to 9.7% by weight of the entire resin composition. For each of the test specimens, the sum of the contents of both these flame retardance-imparting components was set to be 10% by weight or less. For these test specimens, the UL-94 vertical burning test was carried out to evaluate their flame retardance and the moldability of the resin compositions prepared was also assessed. The results are shown in Table 1.

The moldability of the resin composition was determined by whether or not the resin composition was capable of being formed into a desired shape by injection molding or the like using a mold and being formed so as to have a good surface with no sinks occurring, and by whether or not the resin composition was industrially usable from a viewpoint of the time required for molding in a molding cycle or the like. The specific criteria for the evaluation were as follows:

++: level in which there are observed no flow marks, no sinks, and no weld lines, and the molded article can be used as a finished product without coating;
+: level in which there are observed slight flow marks and sinks under careful investigation, but the molded article can be used as a finished product if coating is applied;
−: level in which the surface smoothness is poor, sinks and an orange peel are noticeable, and thus the molded article is unusable even if coating is applied.

TABLE 1

| | | Content of silica-magnesia catalyst particles | | | | | | | | | | | | | | | |
|---|---|---|---|---|---|---|---|---|---|---|---|---|---|---|---|---|---|
| | | (having a particle diameter of 10 μm) (wt %) | | | | | | | | | | | | | | | |
| | | 0 | | | | 0.3 | | | | 1 | | | | 3 | | | |
| | | A | B | C | D | A | B | C | D | A | B | C | D | A | B | C | D |
| Content of | 10 | 27 | Occurred | V2 | − | | | | | | | | | | | | |
| ammonium | 9.7 | | | | | 0 | Not occurred | V0 | + | | | | | | | | |
| polyphosphate | 7 | | | | | 5 | Not occurred | V0 | ++ | 0 | Not occurred | V0 | + | 0 | Not occurred | V0 | + |
| (wt %) | 5 | | | | | 5 | Not occurred | V0 | ++ | 3 | Not occurred | V0 | ++ | 0 | Not occurred | V0 | ++ |
| | 3 | | | | | 8 | Not occurred | V0 | ++ | 6 | Not occurred | V0 | ++ | 2 | Not occurred | V0 | ++ |
| | 1 | | | | | 10 | Not occurred | V0 | ++ | 8 | Not occurred | V0 | ++ | 4 | Not occurred | V0 | ++ |
| | 0.3 | | | | | 20 | Occurred | V2 | ++ | 15 | Occurred | V2 | ++ | 11 | Occurred | V2 | ++ |
| | 0 | | | | | | | | | | | | | | | | |

| | | Content of silica-magnesia catalyst particles | | | | | | | | | | | | | | | |
|---|---|---|---|---|---|---|---|---|---|---|---|---|---|---|---|---|---|
| | | (having a particle diameter of 10 μm) (wt %) | | | | | | | | | | | | | | | |
| | | 5 | | | | 7 | | | | 9.7 | | | | 10 | | | |
| | | A | B | C | D | A | B | C | D | A | B | C | D | A | B | C | D |
| Content of | 10 | | | | | | | | | | | | | | | | |
| ammonium | 9.7 | | | | | | | | | | | | | | | | |
| polyphosphate | 7 | | | | | | | | | | | | | | | | |
| (wt %) | 5 | 0 | Not occurred | V0 | + | | | | | | | | | | | | |
| | 3 | 3 | Not occurred | V0 | + | 0 | Not occurred | V0 | + | | | | | | | | |
| | 1 | 5 | Not occurred | V0 | ++ | 2 | Not occurred | V0 | + | | | | | | | | |
| | 0.3 | 10 | Occurred | V0 | ++ | 8 | Not occurred | V0 | + | 5 | Not occurred | V0 | + | | | | |
| | 0 | | | | | | | | | | | | | 22 | Occurred | V2 | + |

A: Total of primary combustion time and secondary combustion time (seconds)
B: Ignition by dripping
C: UL grade
D: Moldability

As shown in Table 1, flame retardance of grade V2 or V0 of the UL 94 Standard was accomplished when the silica-magnesia catalyst particles and the ammonium polyphosphate as flame retardance-imparting component were added to the poly(lactic acid) (PLA) such that the total amount of these flame retardance-imparting components was 10.0% by weight or less. Any of the compositions resulted in a degree of moldability at which it was also usable as an outer casing for an electric device. Although not shown in Table 1, when the total content of the silica-magnesia catalyst particles and the ammonium polyphosphate exceeded 10.0% by weight, the moldability of the resin compositions was reduced. In this Example, any of the compositions in which 10% of the ammonium polyphosphate alone was contained and in which 10% of the silica-magnesia catalyst particles alone was contained was inferior in flame retardance and moldability. Form these results, it was ascertained that these two flame retardance-imparting components exerted a good flame-retardant effect by combining them.

Form the above-described results, it turned out that in cases of obtaining a flame-retarded resin composition having grade V0 using poly(lactic acid) (PLA) as the resin component and using silica-magnesia catalyst particles and ammonium polyphosphate as the flame retardance-imparting components, it was necessary to add 0.3% by weight or more of the silica-magnesia catalyst particles and 1% by weight or more of the ammonium polyphosphate, or alternatively to mix and add 5% by weight or more of the silica-magnesia catalyst particles and 0.3% by weight of the ammonium polyphosphate.

### Reference Example 1

Flame-retarded resin compositions and test specimens were prepared as in Example 1, except that the ammonium polyphosphate was replaced with a phosphate ester (TPP) having the structure shown below and in which R═H. The shape and dimensions of the test specimens were the same as those in Example 1.

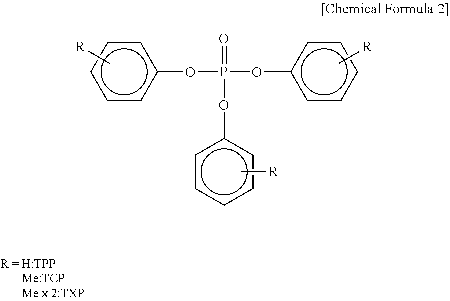

In this Reference Example, plural types of test specimens were prepared by varying the contents of the silica-magnesia catalyst particles and of the phosphate ester. Specifically, the content of the silica-magnesia catalyst particles was varied in the range of 0.3% to 10.0% by weight of the entire resin composition, and at the same time, the content of the phosphate ester was varied in the range of 0.3% to 10.0% by weight of the entire resin composition. For each of the test specimens, the sum of the contents of both these flame retardance-imparting components was set to be 10% by weight or less. For these test specimens, the UL-94 vertical burning test was carried out to evaluate their flame retardancy and the moldability of the resin compositions prepared was also assessed. The results are shown in Table 2.

TABLE 2

| | | Content of silica-magnesia catalyst particles | | | | | | | | | | | |
|---|---|---|---|---|---|---|---|---|---|---|---|---|---|
| | | (having a particle diameter of 10 μm) (wt %) | | | | | | | | | | | |
| | | 0 | | | | 0.3 | | | | 1 | | | |
| | | A | B | C | D | A | B | C | D | A | B | C | D |
| Content | 10 | Burned | Occurred | Not-V | − | | | | | | | | |
| of | | out | | | | | | | | | | | |
| phosphate | 9.7 | | | | | 18 | Occurred | V2 | − | | | | |
| ester | 7 | | | | | 20 | Occurred | V2 | − | 15 | Occurred | V2 | − |
| (wt %) | 5 | | | | | 22 | Occurred | V2 | + | 20 | Occurred | V2 | + |
| | 3 | | | | | 25 | Occurred | V2 | + | 17 | Occurred | V2 | + |
| | 1 | | | | | Burned | Occurred | Not-V | + | Burned | Occurred | Not-V | + |
| | | | | | | out | | | | out | | | |
| | 0.3 | | | | | Burned | Occurred | Not-V | ++ | Burned | Occurred | Not-V | ++ |
| | | | | | | out | | | | out | | | |

| | | Content of silica-magnesia catalyst particles | | | | | | | | | | | | | | | |
|---|---|---|---|---|---|---|---|---|---|---|---|---|---|---|---|---|---|
| | | (having a particle diameter of 10 μm) (wt %) | | | | | | | | | | | | | | | |
| | | 3 | | | | 5 | | | | 7 | | | | 9.7 | | | |
| | | A | B | C | D | A | B | C | D | A | B | C | D | A | B | C | D |
| Content | 10 | | | | | | | | | | | | | | | | |
| of | 9.7 | | | | | | | | | | | | | | | | |
| phosphate | 7 | 10 | Occurred | V2 | + | | | | | | | | | | | | |
| ester | 5 | 18 | Occurred | V2 | + | 9 | Not | V0 | − | | | | | | | | |
| (wt %) | | | | | | | occurred | | | | | | | | | | |
| | 3 | 15 | Occurred | V2 | + | 14 | Occurred | V2 | + | 9 | Not | V0 | − | | | | |
| | | | | | | | | | | | occurred | | | | | | |
| | 1 | 20 | Occurred | V2 | + | 20 | Occurred | V2 | + | 10 | Not | V0 | − | | | | |
| | | | | | | | | | | | occurred | | | | | | |
| | 0.3 | Burned | Occurred | Not-V | ++ | 23 | Occurred | V2 | + | 20 | Occurred | V2 | − | 9 | Not | V0 | − |
| | | out | | | | | | | | | | | | | occurred | | |

A: Total of primary combustion time and secondary combustion time (seconds)
B: Dripping
C: UL grade
D: Moldability

As shown in Table 2, flame retardance of grade Not-V to V0 of the UL 94 Standard was accomplished when the silica-magnesia catalyst particles and the phosphate ester as a flame retardance-imparting component were added to the poly(lactic acid) (PLA) such that the total content of these flame retardance-imparting components was 10.0% by weight or less. However, most of the test specimens exhibited low degrees of flame retardance in comparison with those that contained the polyphosphate salt as the flame retardance-imparting component at the same content. Further, the moldability of each of the compositions which achieved grade V0 in flame retardance was determined to be “−”, that is, a level at which the composition was difficult, from the standpoint of appearance, to be used as an outer casing for an electric device. Also in this Reference Example, the compositions in which 10% of the phosphate ester alone was contained were inferior in flame retardancy and moldability.

From the above-described results, it turned out that in cases of obtaining a flame-retarded resin composition having grade V0 using poly(lactic acid) (PLA) as the resin component and using silica-magnesia catalyst particles and a phosphate ester (TPP) as the flame retardance-imparting components, it was necessary to add 7% by weight or more of the silica-magnesia catalyst particles and 1% by weight or more of the phosphate ester flame retardant, or 5% by weight of the silica-magnesia catalyst particles and 5% by weight of the phosphate ester flame retardant, or alternatively to mix and add 9.7% by weight of the silica-magnesia catalyst particles and 0.3% by weight of the phosphate ester. It, however, proved that when combinations of the silica-magnesia catalyst and the phosphate ester were used in amounts at which flame retardance of grade V0 was allowed to be imparted to resin compositions, the moldability of the resin compositions was reduced to levels which made it difficult to use the resulting molded articles as products.

As is apparent from the above-mentioned Example and Reference Example, when the silica-magnesia catalyst particles and ammonium polyphosphate are contained as the flame retardance-imparting components into a resin component which comprises poly(lactic acid) as the main ingredient and the content of the flame retardance-imparting components is set to be 9.7% by weight or less relative to the flame-retarded resin composition, a sufficient degree of flame retardance can be imparted without deteriorating moldability of the resin composition as an outer casing for electric devices.

In the above-mentioned Example, some cases have been described in which molding was done using an injection molding method by which a resin was melted and subjected to injection molding in a mold having a predetermined shape. An outer casing for an electric device according to the present disclosure may be also formed and produced using a compression molding method by which a flame-retarded resin composition is melted and placed into a female mold and pressure is applied employing the male mold and the female mold.

An outer casing for an electric device according to the present disclosure is produced by employing environmental resins which have a small burden to the environment and possesses flame retardance, and thus the present disclosure is useful in making up outer casings for liquid crystal displays and the like.

### DESCRIPTION OF REFERENCE NUMERALS

1: Display device body
5: Outer casing
6: Front cabinet

What is claimed is:

1. An outer casing for an electric device, which is obtained by molding a flame-retarded resin composition comprising a resin component containing 50% by weight or more of poly(lactic acid) and/or a lactic acid copolymer, and silica-magnesia catalyst particles and a polyphosphate salt as flame retardance-imparting components which impart flame retardancy, wherein the combined content of the silica-magnesia catalyst particles and the polyphosphate salt is 10% by weight or less of the total weight of the flame-retarded resin composition.

2. The outer casing for an electric device according to claim 1, wherein the content of the silica-magnesia catalyst particles is 0.3% or more and 9.70 or less by weight of the total weight of the flame-retarded resin composition.

3. The outer casing for an electric device according to claim 1, wherein the content of the polyphosphate salt is 0.3% or more and 9.7% or less by weight of the total weight of the flame-retarded resin composition.

4. The outer casing for an electric device according to claim 1, wherein the silica-magnesia catalyst particles do not have hydrogen atoms composing crystal water or a hydroxyl group in the molecule.

5. A resin molded article, which is obtained by molding a flame-retarded resin composition comprising a resin component containing 50% by weight or more of poly(lactic acid) and/or a lactic acid copolymer, and silica-magnesia catalyst particles and a polyphosphate salt as flame retardance-imparting components which impart flame retardancy, wherein the combined content of the silica-magnesia catalyst particles and the polyphosphate salt is 10% by weight or less of the total weight of the flame-retarded resin composition.

6. The resin molded article according to claim 5, wherein the content of the silica-magnesia catalyst particles is 0.3% or more and 9.70 or less by weight of the total weight of the flame-retarded resin composition.

7. The resin molded article according to claim 5, wherein the content of the polyphosphate salt is 0.3% or more and 9.7% or less by weight of the total weight of the flame-retarded resin composition.

8. The resin molded article according to claim 5, wherein the silica-magnesia catalyst particles do not have hydrogen atoms composing crystal water or a hydroxyl group in the molecule.
